(19) United States
(12) Patent Application Publication
(10) Pub. No.: US 2003/0173773 A1
(43) Pub. Date: Sep. 18, 2003

(54) Hydraulic or pneumatic assembly device

(76) Inventors: Andreas Udhoefer, Gutersloh (DE); Dieter Westerwalbesloh, Verl (DE)

Correspondence Address: Christopher H. Hunter, 6035 Parkland Boulevard, Cleveland, OH, 44124-4141, US

(21) Appl. No.: 10/368,807

(22) Filed: Feb. 14, 2003

Related U.S. Application Data
(63) Continuation of application No. PCT/DE01/03095, filed on Aug. 25, 2001.

(51) Int. Cl. F16L 35/00

(52) U.S. Cl. 285/18

(57) ABSTRACT

A hydraulic or pneumatic assembly tool with an electronic microprocessor control unit for preparatory manufacture or preassembly of tube or hose connectors. The tool includes a hydraulic or pneumatic drive unit, a function indicator and a hydraulic or pneumatic piston with a tool carrier for the insertion of different workpiece tools. The workpiece tools are selectable according to the workpieces to be machined. The equipment parameters of the workpiece tools, each having certain workpieces to be machined allocated to them, can be transmitted to the microprocessor control unit of the assembly tool. The data of the equipment parameters of each workpiece tool are each transmitted to a transponder system of the control unit by laser radiation or electromagnetic radiation.

This application is a continuation of copending International Application No. PCT/DE01/03095, which designated the United States, and claims priority to German Patent Application 100 40 606.8, filed Aug. 16, 2000, the disclosures of which are incorporated herein by reference.

### FIELD OF THE INVENTION

The invention relates to a hydraulic or pneumatic assembly tool for prepatory manufacture or preassembly of tube or hose connectors.

### BACKGROUND OF THE INVENTION

Special threaded tube connectors using a cutting ring are employed for attaching, for instance, a connecting portion with male thread to the end section of a tube. During preassembly, the cutting ring is forced into the inner cone of a preassembly member. This generally requires an axial movement of the cutting ring relative to the tube so that the cutting ring, with its cutting edge located directly at its front face, will cut into the tube surface and pile up a visible collar.

In tube connectors, such a cutting ring serves as a metallic sealing element in which an elastomer can also act as the sealing component. To make high-quality tube connectors, the cutting rings are, preferably, preassembled with the aid of a preassembly member whose inner contour should correspond to the inner contour of the final-assembly member used at a later stage so that during final assembly at the place of use, following insertion into the final-assembly member, less work will have to be performed. The axial force applied during final assembly is especially intended to ensure that the cutting ring will rest firmly against the inner conical surface of the union socket on all sides with its outer conical surface and cut in completely and positively in the cutting edge area.

A hydraulic device for preassembling a cutting ring or conical ring of a tube connector is known from the German Pat. No. DE 38 43 450 C2. Here the cutting ring and/or the conical ring is forced into an inner cone of a preassembly member by an axial force acting upon it, causing at least one edge of the cutting ring and/or conical ring to cut into the outside of the tube and the tube to be supported at a stop in the preassembly member. In the process, the path compulsorily covered by the cutting ring as a result of the axial force exerted thereon is measured and compared with tolerance values which were previously entered into the device in order to control and monitor the operation.

A corresponding comparison is also made with regard to the pressure values exerted on the workpiece, using an integral pressure sensor. If errors do occur however, e.g. due to the inadvertent insertion of wrong workpieces or tools which, when compared with the tolerance tables entered, are overdimensioned or underdimensioned, detection of the errors can take place, but only after the operation has already started so that the workpieces have to be rejected. This will prevent a defective workpiece from reaching the final assembly, but such a procedure takes up a great deal of time and material.

It is also known to carry out preassembly by means of simple hand tools in conjunction with a vice (vice preassembly). To do so, the fitter threads on the union nut which forces the cutting ring into the preassembly member as far as possible by hand and, subsequently, gives the union nut a specified number of additional turns by means of a spanner so that, allowing for the pitch of the union nut thread, the cutting ring will cover a predetermined path relative to the preassembly member.

Due to the manual operation, such a device will only be suitable for a small number of workpieces to be preassembled.

In the known procedures, variations in the dimensions of the workpieces to be used or in the material properties of the tubes can have the effect that neither in the preassembly nor in the subsequent final assembly, for which a predetermined path of the cutting ring relative to the final assembly member (indicated as a predetermined number of turns of the union nut to be given during final assembly) is specified to the fitter, an adequate strength of the cutting ring anchoring at the tube will be achieved or that the tube will be damaged due to overtightening of the union nut. Furthermore, improper tightening of the union nut can be made worse by the fact that the fitter has to work in a spatially extremely confined environment when carrying out the final assembly. An assembly tool of the type at issue can also be used for tube deformation. In a type adapted to the specific conditions with regard to the operating pressures to be used, the assembly tool can also be employed for the preassembly of hoses.

### SUMMARY OF THE INVENTION

It is an object of the invention to form a device of the above described type in such a way that preassembly of a perfectly satisfactory quality is made possible. A further object of the present invention is to propose a device which is capable of obtaining the working data or equipment parameters which are relevant to the inserted workpieces so that these will be available already prior to commencement of the operation and will initiate the operation only after all conditions regarding the inserted workpieces have been satisfied according to regulations so that proper preassembly is achieved. A further aim of the invention is to avoid manual adjustment of the assembly tool and the errors caused thereby.

According to the invention, the solution of this task lies in the fact that the data of the equipment parameters of each tool are transmissible by means of laser radiation or electromagnetic radiation, in each case using a transponder system.

This will provide the microprocessor of the assembly tool with all the necessary data of the tools and of the workpieces to be machined prior to initiation of the operation so that misadjustments and faulty preassemblies are excluded. It is only after checking and matching of all data determining the assembly process by the microprocessor that the operation will be cleared and initiated. Consequently, all manual adjustments and the associated errors are dropped.

In a preferred embodiment of the invention, the tool includes a hydraulic or pneumatic drive unit, a function indicator, and a hydraulic or pneumatic piston with a tool carrier for the insertion of different workpiece tools. The workpiece tools are selectable according to the dimensions and the material of the workpieces to be machined, and the equipment parameters of the workpiece tools. The workpiece tools each have certain workpieces to be machined allocated to them, and are electromagnetically or optically scannable or readable, which can be transmitted to the microprocessor control unit of the assembly tool.

The housing of the assembly tool includes a recess which receives an assembly kit for insertion of different tools and the machining of different workpieces can be inserted therein. The assembly kit is combined with an electronic distance meter for acquisition of the characteristic parameters of the tools whose measured values can be transmitted automatically to the microprocessor control unit of the assembly tool.

The distance meter is advantageously fitted with a microcontroller and a laser for emitting a laser beam, with the distance meter receiving the laser beam reflected by the tool from a sensor, measuring the angle between the output beam and the reflected input beam, converting the measured value into an electric magnitude in proportion to the distance, viz. into a current or a voltage, and transmitting this value to the microprocessor control unit of the assembly tool, thereby ascertaining a defined pressure and determining the assembly force.

In an improvement of the invention, the light-beam receiver is advantageously designed as a photodiode cell with several lines whose lines can be read out by the microcontroller of the distance meter.

This precludes any further possibility of errors by inputting wrong values or no values at all.

To control the operation of the assembly tool, it is advantageous to equip the assembly tool with at least one pressure sensor for determination of the pressure limiting value during operation. This makes it possible to monitor and control the pressure of the entire operation.

Correspondingly, it is advantageous to equip the control unit of the assembly tool for travel measurement of the operating piston during operation with at least one travel sensor (S sensor).

The electronic control unit is, advantageously, provided with a programmable electronic building block (EPROM) which contains predetermined desired values as electronically readable comparative values so that the operation runs automatically in fully controlled fashion.

This precludes operating errors due to insertion of incorrect tools since the electronics of the assembly tool measures and evaluates the real condition of the workpiece tool, thus avoiding corresponding errors.

In a further advantageous practical example of the invention, the workpiece tool and the control unit of the assembly tool are equipped with a transmission and response system (transponder with send-receive system), with the response system or the transponder sending out complete data for activation of the control unit by means of electromagnetic radiation upon being prompted by the transmission system or the sender, said data being received by the transmission system and transmitted to the control unit via a write and readout device.

The response system and/or the transponder is, preferably, provided with an electronic information store and/or a chip which is connected with the tool and equipped with a resonance coil which, when excited, will send out the resonant frequency modulated with the information data.

Consequently, this is a passive transponder which does not require its own energy supply.

According to the invention, the data of a transponder to be transmitted include all data required for control of the system so that the control unit has not stored any data to be allocated to a specific workpiece. Consequently, the control unit can be used universally since all the necessary data of an operation are supplied directly by the workpiece itself in each case. A comparison of data with predetermined data by the control unit is not possible and not necessary.

### BRIEF DESCRIPTION OF THE DRAWINGS

The invention is explained in more detail in conjunction with the drawing wherein:

FIG. 1 is a diagrammatic representation of a hydraulic assembly tool with assembly kit taken apart in exploded view, shown as a top plan view;

FIG. 2 is an assembly kit in front elevation with a distance meter in diagrammatic and enlarged representation;

FIG. 3 is a further embodiment of a hydraulic assembly tool with a transponder system where a microchip which can be caused to respond by an electromagnetic alternating field is attached to the tool and where, inside the assembly tool, if necessary with external aerial, a send-receive system of the transponder is arranged;

FIG. 3A is a plan view of the workpiece tool for the hydraulic assembly tool; and

FIG. 4 is a cross-section through the structure of a glass transponder.

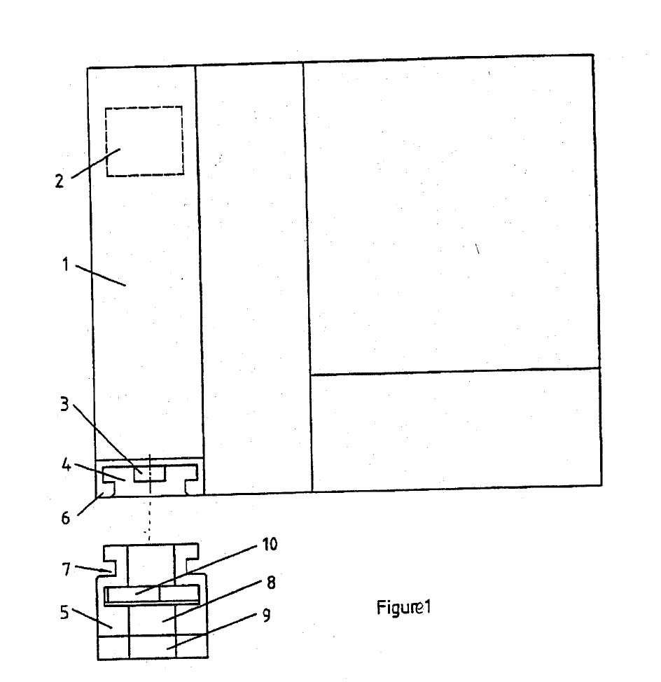

### DETAILED DESCRIPTION OF A PREFERRED EMBODIMENT

Referring to the drawings, the housing 1 of the assembly tool contains a hydraulic drive 2 for a retractable and extensible piston 3 formed in a recess 4 of the housing 1. The recess 4 is designed in such a way that an assembly kit 5 for the insertion of different tools and the machining of different workpieces can be inserted therein. This makes it possible to use different assembly kits so that the assembly tool can also be used, for instance, as a flanging tool. For attachment of the assembly kit 5 there are provided slide bars 6 in the recess 4 and correspondingly formed grooves 7 in the assembly kit 5 which accommodate the slide bars 6 when the assembly kit 5 is introduced into the recess 4 in vertical relation to the drawing plane. Since the travel of the piston 3 takes place in the drawing plane and at a right angle to the slide bars 6, the assembly kit 5 can safely absorb the assembly forces of the piston 3 in any strength provided.

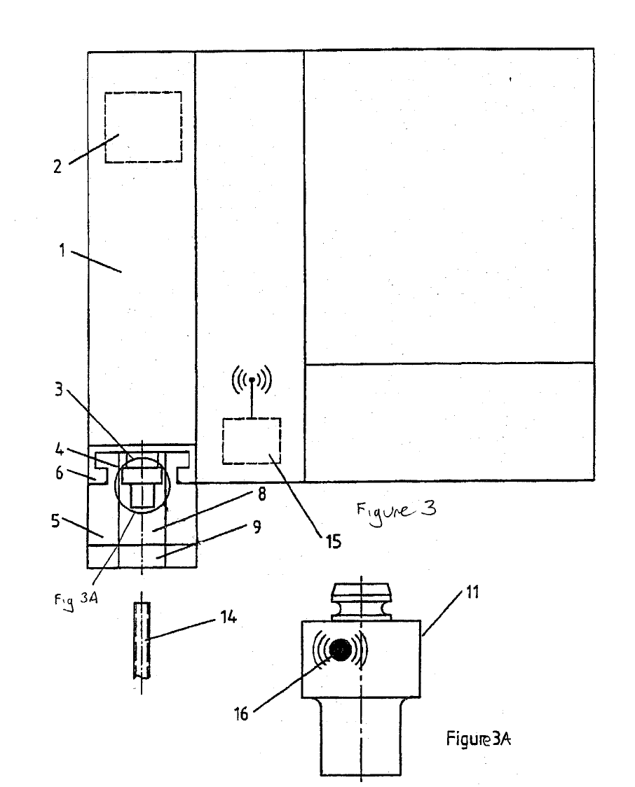

The side of the assembly kit 5 facing the housing 1 is designed completely open so that the piston 3 can retract into the interior 8 of the assembly kit 5. The front side of the assembly kit 5 is also provided with an opening 9 through which the tube end to be machined and, for instance, to be mounted with a cutting ring (see FIG. 3) can be introduced. Furthermore, the assembly kit 5 is open towards the top and partly covered by a distance meter 10 whose beam output 13 is directed onto the tool 11 located in the interior 8 of the assembly kit 5.

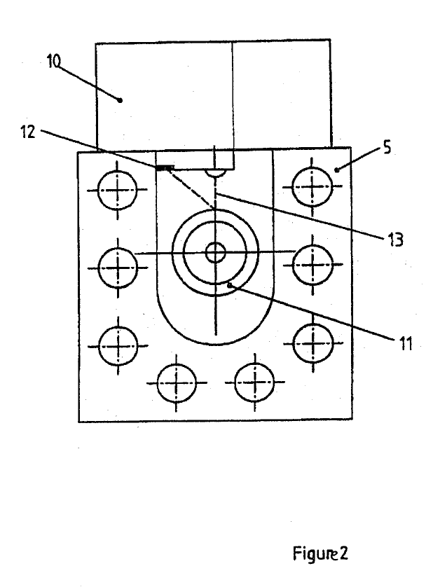

The distance meter 10 is provided with a sensor 12 (see FIG. 2) which is integrated with a microcontroller so that no external evaluating instruments are required. The measuring beam 13 of the distance meter 10 strikes the tool to be measured, whose reflected beam is intercepted by the sensor 12, as a light spot. The outgoing and reflected beams form an angle which is determined by the sensor 12. This measured value is converted into an electric magnitude in proportion to the distance, viz. a current or a voltage, and transmitted to the microprocessor control unit of the assembly tool, thereby ascertaining a defined pressure and determining the assembly force. The assembly tool is thus prepared for the machining of a certain workpiece. The assembly force is thus determined automatically by the automatic distance measurement of the workpiece tool introduced into the assembly kit 5 with the aid of the distance meter 10. If this is the case, the assembly tool will clear the operation and assembly of the cutting ring onto the tube end can be carried out.

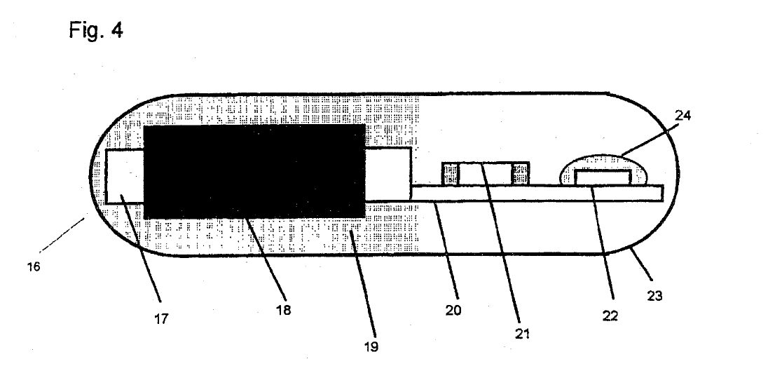

FIG. 3 shows a further embodiment for solution of the same task. For this purpose, a passive transponder comprising a transmission system 15 and a response system 16, the actual transponder, is used. The transmission system 15 is provided with a sender and a receiver. The sender of the transmission system 15 prompts the response system (mini chip 16) which, in principle, consists of a resonance coil and sends out signals modulated with its data which are received by the receiver of the transmission system 15. This receiver demodulates the data received and transmits them to the control unit for further processing and determination of the assembly force. The response system, preferably, consists of a semiconductor store or chip 16 which is connected with the tool and is provided with the resonance coil 18 (FIG. 4) which, upon excitation, modulates the resonant or carrier frequency with its data to be transmitted. Since the distance between the transmission and response system (aerial and transponder) is very short, the response system does not require its own energy source and can, therefore, be designed as a passive system.

FIG. 4 shows the structure of a transponder 16 in cross-section. A ferrite rod 17 surrounded by a coil 18 and arranged on a soft bonding agent 19 is located in a glass housing. A board 20 consisting of an insulator carries a chip capacitor and a semiconductor store or chip 22 (EPROM) embedded in cast resin 24. The EPROM contains predetermined desired values as readable values and allocates input values.

If the coil 18 is excited electromagnetically with its resonant frequency, it will send out the resonant frequency as a carrier frequency, modulated by the data stored in the semiconductor store. Each workpiece having a transponder with data store according to the present invention will transmit all data required for machining of the workpiece to the control system so that the control unit does not require its own data which have to be compared with the data of the workpiece. Consequently, the control unit is universally usable. Therefore, the early error detection and/or error avoidance by the direct transmission of all necessary data by the respective workpiece saves time and material. Furthermore, this will preserve the workpiece tool and the assembly tool and avoid unnecessary wear. No further adjustment or input of certain values for the used and, if necessary, different workpieces is necessary so that the errors and origins of error experienced until now are advantageously eliminated.

What is claimed is:

1. A hydraulic or pneumatic assembly tool with an electronic microprocessor control unit for preparatory manufacture or preassembly of tube or hose connectors, with a hydraulic or pneumatic drive unit, a function indicator and a hydraulic or pneumatic piston with a tool carrier for the insertion of different workpiece tools, the workpiece tools being selectable according to the dimensions and the material of the workpieces to be machined, and the equipment parameters of the workpiece tools; each workpiece tool having certain workpieces to be machined allocated to them, and being electromagnetically or optically scannable or readable and which can be transmitted to the microprocessor control unit of the assembly tool in codified fashion, and a transmission and response system wherein the data of the equipment parameters of each workpiece tool can be transmitted to the assembly tool by laser radiation or electromagnetic radiation.

2. A hydraulic or pneumatic assembly tool as claimed in claim 1, wherein an assembly kit intended for receiving the workpiece tool is combined with an electronic distance meter for acquisition of the equipment parameters of the workpiece tools whose measured values can be transmitted automatically to the microprocessor control unit of the assembly tool, the distance meter being provided with a microcontroller and a laser for emitting a laser beam and the distance meter receiving the laser beam reflected by the workpiece tool from a sensor, measuring the angle between the out beam and the reflected input beam, converting the measured value into an electric magnitude in proportion to the distance and transmitting this value to the microprocessor control unit of the assembly tool, thereby ascertaining a defined pressure and determining the assembly force.

3. A hydraulic or pneumatic assembly tool as claimed in claim 1, wherein the control unit of the assembly tool is equipped with at least one pressure sensor for determining all pressure limiting values during the manufacture or preassembly operation.

4. A hydraulic or pneumatic assembly tool as claimed in claim 1, wherein the microprocessor control unit of the assembly tool is equipped with at least one travel sensor for travel measurement of the operating piston during the manufacture or preassembly operation.

5. A hydraulic or pneumatic assembly tool as claimed in claim 1, wherein the electronic microprocessor control unit is provided with a programmable electronic building block which contains predetermined desired values as readable comparative values and allocates input values.

6. A hydraulic or pneumatic assembly tool as claimed in claim 1, wherein a workpiece tool and the control unit of the assembly tool are equipped with an electromagnetic transmission and response system, with the response system sending out equipment parameters upon being prompted by the transmission system, said data being received by the transmission system and transmitted to the control unit.

7. A hydraulic or pneumatic assembly tool as claimed in claim 6, wherein the response system consists of a mini chip internal with a workpiece tool and has a resonance coil which, when excited, sends out stored equipment parameters.

8. A hydraulic or pneumatic assembly tool as in claim 7, wherein the data of the equipment parameters to be transmitted by the response system include all of the data required for control of the system.

9. A hydraulic or pneumatic assembly tool as in claim 8 wherein the response system has an external data store, which when prompted by the transmitter, will transmit its data via a write/read device to the microprocessor control unit.
